(19) United States
(12) Patent Application Publication
(10) Pub. No.: US 2005/0287059 A1
(43) Pub. Date: Dec. 29, 2005

(54) Uranium isotope separation through substitution reactions

(76) Inventor: Robert Indech, Norcross, GA (US)

Correspondence Address: Wilson Daniel Swayze, Jr, 3804 Clearwater Ct, Plano, TX, 75025, US

(21) Appl. No.: 11/023,946

(22) Filed: Dec. 28, 2004

Related U.S. Application Data
(60) Provisional application No. 60/583,250, filed on Jun. 28, 2004.

(51) Int. Cl. C01G 43/00

(52) U.S. Cl. 423/253

(57) ABSTRACT

A method and apparatus for obtaining concentrated U-235 and concentrated U-238 includes the steps of forming a silicon dioxide structure, flowing uranium gas containing U-235 and U-238 isotopes over the silicon dioxide structure, and obtaining the concentrated U-238 in the gas and the concentrated U-235 in the structure by allowing U-235 to be preferentially absorbed in the silicon dioxide structure through an oxidation-reduction reaction.

### BACKGROUND OF ISOTOPE SEPARATION TECHNIQUES

The production of electrical energy in a nuclear generating station requires the use of uranium enriched in the radioactive isotope U-235. This invention presents a new method to obtain concentrated U-235.

An isotope of a given element has the same number of protons and electrons of the given atomic element but has a differing number of neutrons. This addition of neutrons to create the isotope changes the weight of the atom. The resulting variation in separation distance between the protons in the nucleus slightly changes the atomic volume through modification of the electronic wave function of the outermost electron shell. Further, this modification of the wave function changes the atomic absorption optical spectra.

The weight difference between isotopes may be profound as with the atomic weight differences of the isotopes of hydrogen. Here, deuterium with one neutron has two times the weight of atomic hydrogen, and tritium with two neutrons has three times the weight of atomic hydrogen. Alternatively, the weight difference may be small, as with uranium. Natural uranium contains 99.3% of the U-238 isotope and 0.7% of the U-235 isotope.

It is desirable to be able to separate isotopes of the elements. For example, deuterium and tritium are utilized in the production of nuclear munitions. Uranium that is enhanced in the U-238 species is termed “depleted uranium” and is used for its penetration abilities in conventional warheads. Uranium that is enhanced in the U-235 species is significantly radioactive and at 0.7-5% concentration is used for Light Water Reactors, and at 90% concentration is used for nuclear weapons. The isotope of oxygen with 10 neutrons, O-18, is used in nuclear magnetic resonance spectroscopy. The stable isotope C-13 is promising for medical applications, particularly for breath analyzer tests. Other isotopes, such as Tc-99m and TI-201 are extensively used in medical applications such as microwave tomography.

The majority of isotope separation techniques utilize this slight mass difference between isotopes for their separation. One major technique, gaseous diffusion, depends on the fact that the isotope with the larger atomic mass has a smaller mean velocity. This fact derives from the constancy of the mean kinetic energy of the atom at a given temperature, computed as one half the product of the atomic mass times the square of the mean atomic translational velocity. Thus, the higher velocity isotope will preferentially diffuse through a porous membrane. After cascading many columns of gaseous diffusion, a highly concentrated isotope will eventually emerge. However, to reach the concentration desired, sometimes thousands of such cascaded diffusion columns are necessary. This was the technique used in World War II to provide the U-235 needed for its atomic weapons.

An alternative diffusion technique is thermal diffusion that relies on a temperature gradient to concentrate one type of molecule in the cold region and another type in the hot region. However, this effect also depends on the forces between molecules, causing the direction of separation to possibly reverse as the temperature or relative concentration is changed. Thermal diffusion is not practical in the separation of uranium isotopes.

Another major isotope separation technique is high-speed centrifugation. Here, the heavier species, under a uniform acceleration gradient will tend to settle at the outermost radius of the rotating centrifuge apparatus. The separation is incomplete, and multiple stages are needed for the proscribed isotope purity. The centripetal acceleration of the device can exceed a value of 5×10⁵ g, generating a separation factor as high as 1.06 for the U-235 and U-238 hexaflouride gases.

Electromagnetic isotope separation, developed in the early 1940's in the Manhattan Project, and then abandoned, has been revitalized in the IRAQ nuclear program. In this technique, ions of U-238 and U-235 are separated because they describe arcs of different radii when acted upon by a strong magnetic field.

A newer commercial technique is laser enrichment, whereupon a laser is specifically tuned to ionize a U-235 atom, but not a U-238 atom. This technique is based on isotope shifts in the atomic absorption optical spectra. Positively charged U-235 ions are attracted to a negatively charged plate and collected. While this technique profits from its overall compactness, it is inefficient and slow in the generation of commercial quantities of U-235. As of a report in July 2003, this process was not yet ready for commercial use.

Initial Processing of Uranium from the Mine:

Uranium leaves the mine as the concentrate of a stable oxide known as uranium trioxide, U₃O₈, or as peroxide. After initial refining, uranium trioxide is hydrogen reduced in a kiln to uranium dioxide, UO₂. This product is then reacted with hydrogen fluoride to form uranium tetrafluoride, UF₄. This second product is then reacted with gaseous fluorine to produce uranium hexafluoride, UF₆, impurities being removed along the way. Uranium hexafluoride is highly corrosive. It is typically cooled into the liquid form and shipped for isotope separation in this liquid form.

Nanoparticle Structures and Displacement Reactions:

Certain biological organisms create intricate three dimensional nanoparticle structures. For example, diatom microshells create a silicon dioxide (SiO₂) detailed structure. Brittlestars create calcitic skeletons. Alternatively, it is not difficult in the laboratory to create a uniform SiO₂ layer on various substrates. These chemical deposition techniques have been known for some time in the microelectronics fabrication industry, although the surfaces created are typically two dimensional, rather than the three dimensional SiO₂ surfaces created in nature. Further, one can create very small particles of a substrate and then form a uniform coating of SiO₂ on them. This creates a chemically pure form SiO₂ surface layer with a maximal surface to volume ratio.

In order to preserve the SiO₂ biological microstructure, Unocic teaches the use of the following displacement (oxidation-reduction) reaction:
TiF₄(g)+SiO₂(s)→TiO₂(s)+SiF₄(g)
Solid TiF₄ is utilized as a low temperature source of TiF₄ vapor. The titanium substitutes one for one with the silicon, retaining the three dimensional morphology of the silicon dioxide microstructure. It is important to control both the temperature of reaction and the TiF₄—SiO₂ molar ratio to obtain the best titanium to silicon substitution. The resulting SiF₄ gas is then cleared, leaving the solid titanium oxide structure. Sandhage teaches the use of other substitution reactions for silicon inside this three dimensional SiO₂ microstructure. In particular, evaporated magnesium at 900° C. undergoes the following displacement (oxidation-reduction) reaction:
2Mg(g)+SiO₂(s)→2MgO(s)+Si
whereupon the residual silicon is dissolved within a Mg—Si liquid. Sandhage teaches other examples of thermodynamically favorable substitution reactions utilizing AlF₃(g), Ca(g), FeF₃(g), Li(g), NbF₅(g), Sr(g), TaF₅(g), and ZrF₄(g). In all cases, the free energy of reaction is negative, indicating that the reaction will proceed. Reaction temperatures vary from 800° C. to 1200° C.

Xu teaches the gas separation properties of various advanced polymer materials. In his article, he notes an increase in gas diffusion coefficients and a decrease in diffusion selectivities that is correlated with an increase of polystyrene nanoparticles in a pyromellitic dianhydride/oxydianiline polyimide membrane. Thus, the structure of the membrane itself is key to the particular gas diffusion constant.

The following references are incorporated by reference in their entirety.

Baranov, V. Yu.: “Isotope Technologies.” Institute of Molecular Physics, Russian Research Center “Kurchatov Institute”. http://www.imp.kiae.ru/_eng/tehn/tehn_txt.htm

Nuclear Weapons Archive. Chapter IX. General Discussion of the Separation of Isotopes. 9.1-9.45. http://nuclearweaponarchive.org/Smyth/Symth9.html

Sandhage, Kenneth et. al.: “Novel, bioclastic route to self-assembled, 3D, chemically tailored meso/nanostructures: shape-preserving reactive conversion of biosilica (diatom) microshells.” Adv. Mater. 2002, 14, No. 16, Mar 18. pp. 429-433.

Unocic, Raymond et. al.: “Anatase assemblies from algae: coupling biological self-assembly of 3-D nanoparticle structures with synthetic reaction chemistry.” Chem. Commun. 2004, (7), pp. 796-797.

Uranium Enrichment: Nuclear Issues Briefing Paper 33, June 2003. http://www.uic.com.au/nip33.htm

Uranium Ore Deposits. pp. 1-4. 9 Jun. 2003. http://www.antenna.nl/wise/uranium/uod.html

US Patent Application 20030099763, May 29, 2003. Sandhage, K.: Shaped microcomponent via reactive conversion of biologically-derived microtemplates.

US Patent Application 20030044515, Mar. 6, 2003. Sandhage, K.: Shaped microcomponents via reactive conversion of synthetic microtemplates.

Weast, Robert: CRC Handbook of Chemistry and Physics, 1985. Table of Chemical Thermodynamic Properties. D60-62.

Xu, Zhi-Kang et. al.: “Gas separation properties of PMDA/ODA polyimide membranes filling with polymeric nanoparticles.” J. Memb. Sci. 2002, (6), 202, ½, pp. 27-35.

### SUMMARY

A process and an apparatus to be used for separation of the two major isotopes of uranium are described. Overall, a uranium hexafluoride gas is passed over a silicon dioxide surface, with or without porous microstructure, leading to a preferential displacement reaction of the U-235 isotope for the silicon

### BRIEF DESCRIPTION OF THE DRAWINGS

FIG. 1 illustrates an apparatus of the present invention;

FIG. 2 illustrates a flow chart of the present invention.

### DETAILED DESCRIPTION

Uranium hexafluoride (UF₆), a gas, is passed over a substrate bearing a uniform coating of SiO₂. The silicon dioxide coating will be on a continuous solid surface or on substrate microparticles. Under the appropriate heat and pressure conditions, UF₆ will undergo an oxidation-reduction reaction wherein the uranium will displace the silicon, producing silicon-fluoride gas as a byproduct. The UF₆ is composed of the heavier uranium isotope U-238, and the lighter isotope U-235. The lighter isotope, having a higher diffusivity, will preferentially undergo the above displacement reaction, leading to a greater concentration of U-235 on the substrate, and a depleted UF₆, richer in U-238, in the gas form. The depleted uranium UF₆ gas is then cleaned of the fluorine, yielding a higher concentration of depleted uranium (U-238), which is then conventionally processed. After reaction completion, the substrate is removed from the reaction chamber, and the uranium (enhanced in U-235) is chemically extracted from the substrate. If the required purity is not achieved, this uranium is then reprocessed into uranium hexafluoride and the process is repeated.

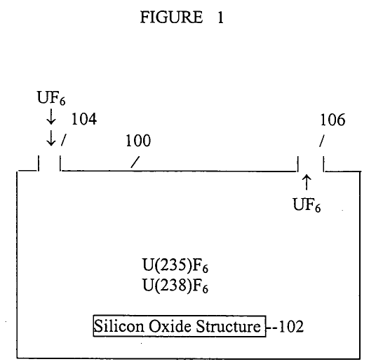

FIG. 1 illustrates one such apparatus to obtain depleted U-238 and concentrated U-235. Referring now to FIG. 1, a container 100 is used to contain uranium hexafluoride gas as it enters an input 104 to the container 100, the uranium hexafluoride gas passes over the silicon dioxide microstructure 102 and the resulting uranium hexafluoride gas with a higher concentration in U-238 exits the container 100 at output 106. Pores in the silicon-dioxide microstructure 102 enhance the selectivity of isotope separation.

Consider the process in detail. Uranium is converted into a gaseous uranium-hexaflouride.

When this gas is placed over a silicon-dioxide microstructure 102 under the proper pressure and temperature, and in the stochiometric molar ratio of UF₆ to SiO₂, the following overall reaction occurs:
UF₆(g)+( 3/2)SiO₂(s)→UO₃(s)+( 3/2)SiF₄(g)
To investigate whether this reaction will spontaneously occur, consider its overall thermodynamics, with comparison to the TF₄—SiO₂ reaction. Consider the overall enthalpy of the reaction in Kcal/mole (uranium):
(−505)+( 3/2)×(−205)→(−302)+( 3/2)×(−370)
or, a net heat gain of positive 44 Kcal/mole (uranium), indicating a favorable reaction.

By comparison, the titanium-fluoride displacement reaction is:
TiF₄(g)+SiO₂(s)→TiO₂(s)+SiF₄(g).
Examination of the overall enthalpy of this reaction in Kcal/mole yields:
(−370)+(−205)→(−218)+(−370)
or, a net heat gain of 13 Kcal/mole (titanium), indicating a favorable reaction.

One may also consider two possible intermediate products within this overall reaction, UO₂F₂ and Si₂OF₆:
UF₆(g)+SiO₂(s)→UO₂F₂(s)+SiF₄(g)
UF₆(g)+( 4/3)SiO₂(s)→UO₂F₂(s)+(⅔)Si₂OF₆(g)
Then:
UO₂F₂(s)+(½)O₂(g)→UO₃(s)+F₂(g)
By examination of overall enthalpy, these intermediate product reactions are also energetically favorable.

The gaseous uranium-hexaflouride UF₆ includes the U-235 isotope and the U-238 isotope. These two isotopes are passed over the silicon-dioxide microstructure 102 to concentrate the U-238 isotope in the gas by allowing the U235 isotope to preferentially be formed with the silicon-dioxide microstructure. The amount of U-235 isotope formed with silicon-dioxide microstructure 102 depends on surface chareristics of the microstructure. The more porous the microstructure 102; the more U-235 is formed with the silicon-dioxide microstructure 102. This increases the relative amount of U-238 isotope in the gaseous uranium-hexaflouride UF₆.

With or without a porous silicon-dioxide microstructure 102, the increased molecular velocity of the U-235 isotope over the U-238 isotope will consequently cause a preference of the U-235 isotope to participate in the above reaction. Further, since the slightly smaller size of the U-235 atom will fit better into the silicon-dioxide microstructure 102, this isotope will be favored in the displacement reaction. That is, the interatomic forces of the silicon atoms in the existing silicon-dioxide matrix tends to more readily allow substitution of the smaller uranium atoms, all other things being equal. This equality is enforced as we are considering two almost identical isotopes of uranium, U-235 and U-238, with similar valence, and orbital shells.

To this point, we have considered surface displacement reactions. If the silicon-dioxide microstructure 102 of a diatom or other silicon-dioxide shelled microorganism is selected for its three dimensional morphology, and it has a large number of micro-pores, then the U-235 isotope will preferentially diffuse into these pores to react with the silicon-dioxide microstructure 102 in the interior of the diatom. Thus, as a result of this substitution reaction, the resultant uranium-hexafluoride gas will be enhanced in U-238 and the substrate will be enhanced in U-235. This new isotope separation method utilizes the known enhancement of the gaseous diffusion isotope separation technique previously discussed with a porous media as well as the increased selectivity based upon atomic size and diffusivity.

After the substitution reaction goes to its desired level of completion, the resultant UF₆ gas is removed from the reaction container 100, and then chemically cleaned of the fluorine, yielding depleted uranium. Further, after substitution reaction completion, the substrate is removed from the reaction chamber, and the uranium (enhanced in U-235) is chemically extracted from the substrate. The uranium extraction technique, involving removing pure uranium from the uranium-oxide surface, is well known to those skilled in the art. If the desired purity is not achieved, the U-235 enhanced uranium is then reprocessed into uranium hexafluoride and the process is repeated.

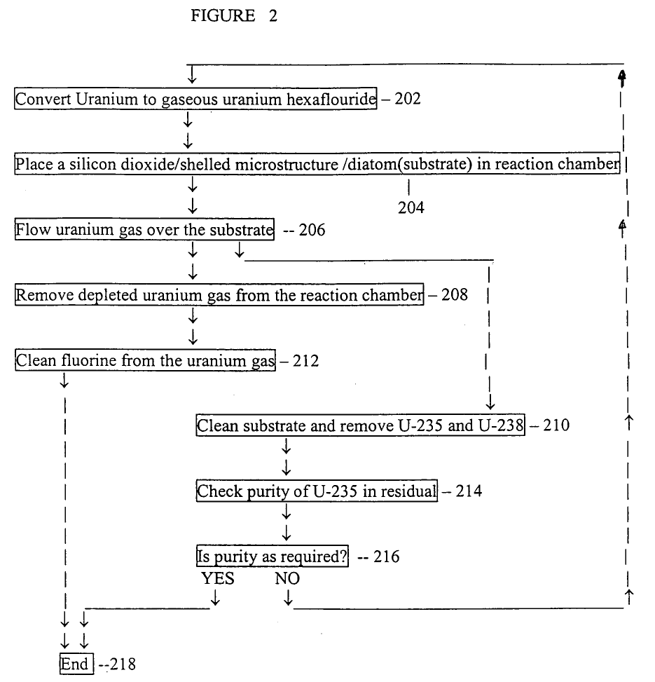

FIG. 2 illustrates a flow chart of the present invention. At step 202, uranium is converted to gaseous uranium hexafluoride. Next, at step 204, a silicon dioxide microstructure 102 is placed in container 100. Next, at step 206, the uranium gas including isotopes U-235 and U-238 is input to the input 104 of container 100. The U-235 isotope is more preferentially absorbed by the silicon dioxide microstructure 102. At step 208, the uranium fluoride gas concentrated in U-238 is removed from the reaction container 100. At step 212, the fluorine is cleaned from the uranium fluoride gas to obtain uranium enhanced in concentration in isotope U-238. In parallel with steps 208 and 212, the substrate is cleaned in step 210, yielding a mix of U-235 and U-238. At step 214, this mix is physically measured for the molar concentration of U-235. If, at step 216 it is determined that the reaction has reached a desired level of completion, then the process ends in step 218. If the reaction has not reached a desired level of completion, control returns to step 202.

It is specifically noted that the substitution reaction of uranium for silicon is not specific for U-235 to the complete exclusion of U-238. Rather, the effect of the substitution reaction will vary the molar concentration of U-235 to U-238 both in the residual uranium hexaflouride gas and in the uranium adsorbed to the solid surface. It is fully expected that many iterations of the process will be required to obtain the purity level of U-235 or of U-238 needed for particular commercial or military applications.

The present invention has the marked advantage of very little waste of intermediate byproducts. Further, the reaction is compact, utilizing few components and possesses a well-defined endpoint.

1) A method for obtaining concentrated uranium isotope 235 (U-235) and concentrated uranium isotope 238 (U-238), comprising the steps of:
forming a silicon dioxide structure;
flowing a uranium gas composed of U-235 and U-238 isotopes over said silicon dioxide structure;
obtaining said concentrated U-235 in the structure by allowing U-235 to be absorbed through an oxidation-reduction reaction in said silicon dioxide structure;
obtaining said concentrated U-238 in the gas by allowing U-235 to be absorbed through an oxidation-reduction reaction in said silicon dioxide structure.

2) A method for obtaining concentrated U-235 as in claim 1, wherein said silicon dioxide structure is a silicone dioxide microstructure.

3) A method for obtaining concentrated U-235 as in claim 2, wherein said silicon dioxide microstructure is obtained by using a diatom.

4) A method for obtaining concentrated U-235 as in claim 2, wherein said silicon dioxide microstructure is obtained with a silicon dioxide shelled microorganism.

5) A method for obtaining concentrated U-238 as in claim 1, wherein said silicon dioxide structure is a silicone dioxide microstructure.

6) A method for obtaining concentrated U-238 as in claim 2, wherein said silicon dioxide microstructure is obtained by using a diatom.

7) A method for obtaining concentrated U-238 as in claim 2, wherein said silicon dioxide microstructure is obtained with a silicon dioxide shelled microorganism.

8) A method for obtaining concentrated U-235 as in claim 1, wherein said concentrated U-235 has reached a level of completion and then said flow of said uranium gas is stopped.

9) An apparatus for obtaining concentrated U-235, comprising:
a silicon dioxide structure;
a container including said silicon dioxide structure having a input and an output;
wherein a uranium gas composed of U-235 and U-238 isotopes flows over said silicon dioxide structure to obtain said concentrated U-235 by allowing U-235 to be absorbed in said silicon dioxide structure by an oxidation-reduction reaction.

10) An apparatus for obtaining concentrated U-235 as in claim 9, wherein said silicon dioxide structure is a silicone dioxide microstructure.

11) An apparatus for obtaining concentrated U-235 as in claim 10, wherein said silicon dioxide microstructure is obtained by using a diatom.

12) An apparatus for obtaining concentrated U-235 as in claim 10, wherein said silicon dioxide microstructure is obtained with a silicon dioxide shelled microorganism.

13) An apparatus for obtaining concentrated U-235 as in claim 9, wherein said concentrated U-235 has reached a level of completion and then said flow of said uranium gas is stopped.

14) An apparatus for obtaining concentrated U-238, comprising:
a silicon dioxide structure;
a container including said silicon dioxide structure having an input and an output;
wherein a uranium gas composed of U-235 and U-238 isotopes flows over said silicon dioxide structure to obtain said concentrated U-238 in said uranium gas by allowing U-235 to be absorbed in said silicon dioxide structure by an oxidation-reduction reaction.

15) An apparatus for obtaining concentrated U-238 as in claim 14, wherein said silicon dioxide structure is a silicone dioxide microstructure.

16) An apparatus for obtaining concentrated U-238 as in claim 15, wherein said silicon dioxide microstructure is obtained by using a diatom.

17) An apparatus for obtaining concentrated U-238 as in claim 15, wherein said silicon dioxide microstructure is obtained with a silicon dioxide shelled microorganism.

18) An apparatus for obtaining concentrated U-238 as in claim 14, wherein said concentrated U-238 has reached a level of completion and then said flow of said uranium gas is stopped.
